(19) United States
(12) Patent Application Publication
(10) Pub. No.: US 2026/0357935 A1
(43) Pub. Date: Nov. 12, 2026

(54) PRESSURE-BALANCED SLIP JOINT

(71) Applicant: General Electric Company, Evendale, OH (US)

(72) Inventor: Logan Randall Doster, Lebanon, OH (US)

(21) Appl. No.: 19/205,107

(22) Filed: May 12, 2025

(51) Int. Cl. F16L 27/12; F16L 51/00

(52) U.S. Cl. CPC F16L 27/125; F16L 51/00

(57) ABSTRACT

A pressure-balanced slip joint includes a piston housing defining a piston chamber, a first sealing assembly coupled to one end of the piston housing, a second sealing assembly coupled to an opposite end of the piston housing, a fluid conduit with an internal passageway, and a piston disposed within the piston chamber and coupled to the fluid conduit. A first pressure chamber is defined between a first end surface of the piston and an end surface of the first sealing assembly and a second pressure chamber is defined between a second end surface of the piston and an end surface of the second sealing assembly. The fluid conduit has a fluid passageway connecting the internal passageway of the fluid conduit to the second pressure chamber so that a static pressure in the second pressure chamber is a static pressure P_{S} of a fluid in the slip joint.

### TECHNICAL FIELD

The present disclosure relates generally to slip joints and, more particularly, to pressure-balanced slip joints.

### BACKGROUND

In some machines or devices, two components may be fluidly connected together so as to have a fluid (e.g., liquid or gas) flowing through a fluid passageway extending between them. During the operation of the machine, one or both of those two components may move in translation and/or rotation relative to each other because of mechanical and/or thermal loads. Thus, using a fixed or rigid fluid line, such as fixed tubing, piping, ducting, etc., may be problematic because such a fixed or rigid fluid line coupler does not permit the two components to move relative to each other.

To accommodate such relative motion, a slip joint may be used to extend between the two components, where the slip joint allows fluid, often pressurized, to flow therethrough, but also permits relative motion between the two components.

### BRIEF DESCRIPTION OF THE DRAWINGS

The accompanying drawings, which are incorporated in and constitute a part of this specification, illustrate one or more embodiments of the present disclosure and, together with a general description given above, and the detailed description given below, serve to explain the one or more embodiments of the present disclosure.

FIG. 1 is a schematic representation of a known arrangement of one fixed or movable device rigidly connected to another fixed or movable device, with a fluid passageway extending therebetween.

FIG. 2 is a schematic representation of a known arrangement of the two fixed or movable devices of FIG. 1 connected by a slip joint having a fluid passageway extending therethrough.

FIG. 3 is a perspective view of a pressure-balanced slip joint according to an embodiment of the present disclosure.

FIG. 4 is a cross-section view of the pressure-balanced slip joint of FIG. 3, taken along line 4-4 of FIG. 3.

FIG. 4A is a similar view of the pressure-balanced slip joint of FIG. 4, with the piston and fluid conduit moved in a rightward direction relative to the piston housing.

FIG. 4B is a cross-section view of a pressure-balanced slip joint with a two-piece fluid conduit according to an embodiment of the present disclosure.

FIG. 5A is a cross-section view of the pressure-balanced slip joint of FIG. 4, taken along line 5A-5A of FIG. 4.

FIG. 5B is a cross-section view of the pressure-balanced slip joint of FIG. 4, taken along line 5B-5B of FIG. 4.

FIG. 6 is a cross-sectional view of the pressure-balanced slip joint of FIG. 3, with a heat shroud enveloping the slip joint according to an alternate embodiment of the present disclosure.

FIG. 7 is a cross-sectional view of the pressure-balanced slip joint of FIG. 3, with a heat shroud enveloping the slip joint according to another embodiment of the present disclosure.

FIG. 8 is a cross-sectional view of a pressure-balanced slip joint with two pistons according to another embodiment of the present disclosure.

FIG. 9A is a cross-section view of the pressure-balanced slip joint of FIG. 8, taken along line 9A-9A of FIG. 8.

FIG. 9B is a cross-section view of the pressure-balanced slip joint of FIG. 8, taken along line 9B-9B of FIG. 8.

FIG. 9C is a cross-section view of the pressure-balanced slip joint of FIG. 8, taken along line 9C-9C of FIG. 8.

### DETAILED DESCRIPTION

Many known slip joints use large external apparatuses or externally-applied pressure to counteract internal plug loads caused by the static pressure of the fluid interacting with the internal components of the slip joint. As used herein, a plug load is the force that the static pressure of the fluid exerts on the internal component of the slip joint. The plug load tends to cause the slip joint to expand. Moreover, because the plug load results from the static pressure of the fluid, the plug load is present in the slip joint regardless of the direction of the fluid flow through the slip joint. These slip joints are typically heavy and complex and not conducive to being used in applications where space is limited and weight must be minimized, such as in jet engines by way of example.

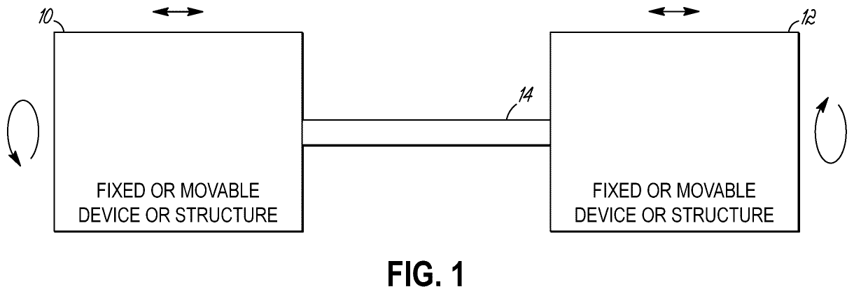

Referring now to the figures, FIG. 1 diagrammatically illustrates a known arrangement of a first device or structure 10 and a second device or structure 12 fluidly coupled together with a rigid fluid passageway or conduit 14, such as a tube or pipe, extending therebetween. The conduit 14 is configured to carry fluid (e.g., liquid or gas) between the first and second structures 10, 12. During use, one or both of the first and second structures 10, 12 may experience translation and/or rotation (as represented by the arrows) relative to each other because of vibrations and mechanical and/or thermal loads, for example. The conduit 14, however, does not permit such relative motion and, consequently, the conduit 14 and/or the first and second structures 10, 12 may be damaged under certain mechanical and/or thermal loads.

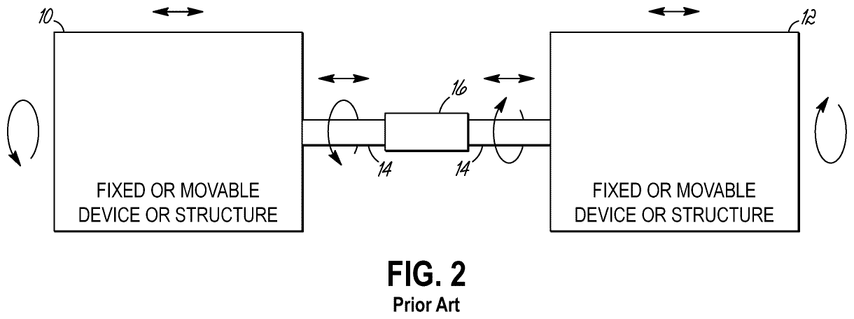

To address the issues encountered with fluidly connecting two structures together, a slip joint may be used to convey fluid between the two structures that are movable relative to each other, i.e., one structure may move and the other structure may be fixed or both structures may move. The slip joint permits not only fluid flow between the two structures, but also permits relative motion between the two structures. For example, FIG. 2 shows the first and second structures 10, 12 connected by the conduit 14, but with a slip joint 16 disposed along the conduit 14. The slip joint 16 permits the first and second structures 10, 12 to move relative to each other and also allows a fluid to flow therebetween. Known slip joints, however, may use large external apparatuses or externally-applied pressure to counteract internal plug loads. Such slip joints may not be suitable for environments where space is limited and weight must be minimized, such as in jet engines.

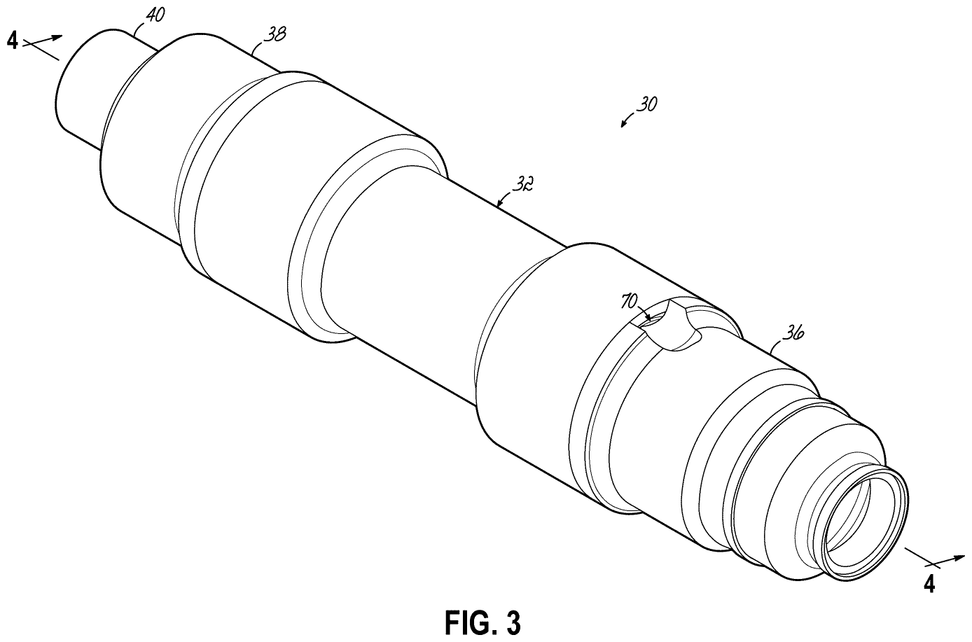

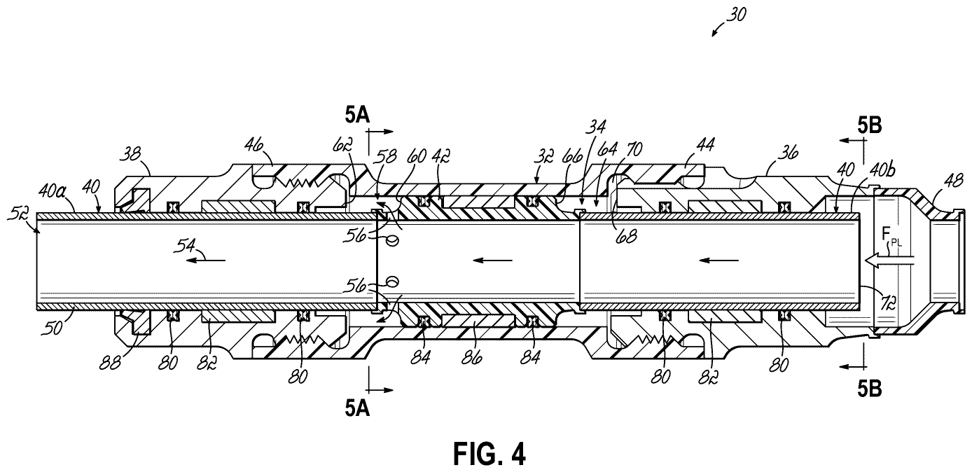

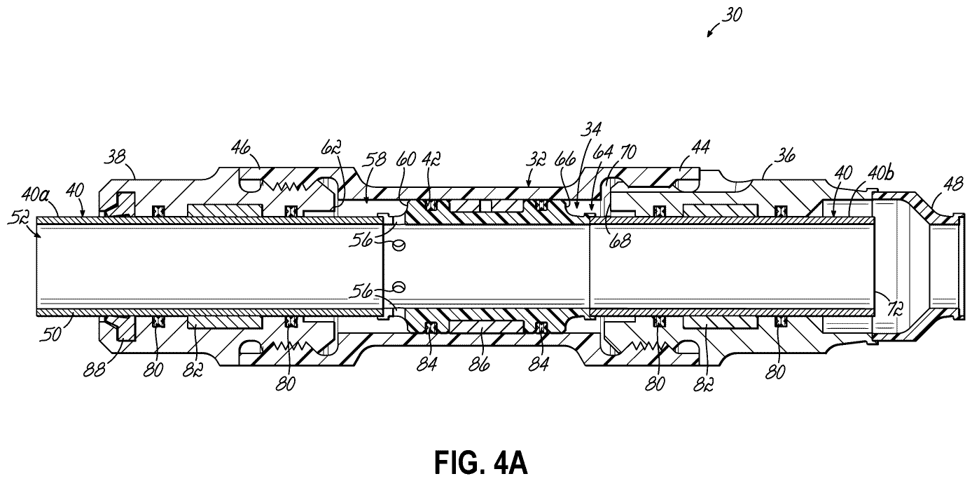

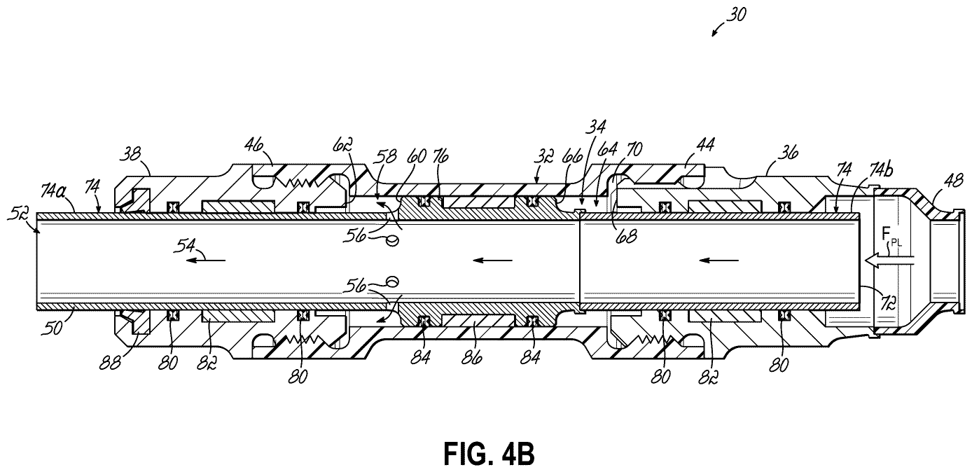

FIGS. 3 and 4 show a pressure-balanced slip joint 30 according to an embodiment of the present disclosure. The exemplary slip joint 30 includes a piston housing 32 defining a piston chamber 34, a first sealing assembly 36, a second sealing assembly 38, a fluid conduit 40, and a piston 42 disposed within the piston chamber 34 and operatively coupled to the fluid conduit 40. The first sealing assembly 36 is operatively coupled to one end 44 of the piston housing 32 and the second sealing assembly 38 is operatively coupled to an opposite end 46 of the piston housing 32. In an embodiment, the first sealing assembly 36 may be threadingly coupled to end 44 of the piston housing 32 and the second sealing assembly 38 may be threadingly coupled to end 46 of the piston housing 32. The threading configuration allows the first and second sealing assemblies 36, 38, to be readily installed on and removed from piston housing 32. In this way, the slip joint 30 may be disassembled to obtain access to the internal components of the slip joint 30 so that they may be replaced or modified. As shown in FIG. 4, the first and second sealing assemblies 36, 38 extend away from the piston housing 32 in a longitudinal direction along portions of the fluid conduit 40 which helps to provide lateral stability against side loads that the slip joint 30 may experience. In an embodiment, a fluid conduit coupler 48 may be coupled to the first sealing assembly 36. The fluid conduit coupler 48 is configured to receive a fluid conduit (not shown) that may connected to a structure, such as the second structure 12 in an exemplary embodiment. In one embodiment, the slip joint 30 may be made of nickel, stainless steel, and/or titanium (e.g., Inconel-625, 321-SS, Ti 6-4, Ti 2-2.5), although other suitable materials may be used as well.

The fluid conduit 40 includes a tubular wall 50 that defines an internal passageway 52 configured to allow fluid to flow therethrough. As shown in FIG. 4, the fluid may flow from right to left through the internal passageway 52 as indicated by arrows 54. While the fluid is shown flowing from right to left in FIG. 4, the slip joint 30 may also accommodate fluid flowing from left to right as well. The fluid flowing through the internal passageway 52 has a static pressure P_{S}, which is present in the fluid regardless of the direction of the fluid flow. In an embodiment, the fluid conduit 40 may be a continuous conduit, or it may be made in at least two sections with the piston 42 disposed between and coupled to the two sections. In an embodiment, the fluid conduit 40 may be made from first fluid conduit section 40a and a second fluid conduit section 40b and the piston 42 may be arranged in an abutting, end-to-end relationship with the first and second fluid conduit sections 40a, 40b as shown in FIG. 4. However, other arrangements and engagements of the first and second fluid conduit sections 40a, 40b, may possible as well. In the arrangement in FIG. 4, the piston 42 forms part of the internal passageway 52 along with the first and second fluid conduit sections 40a, 40b of the fluid conduit 40. The fluid conduit 40 and the piston 42 are configured to move relative to the piston housing 32. The movement of the fluid conduit 40 and the piston 42 may be linear and/or rotational relative to the piston housing 32 when one or both of the first or second structures 10, 12 move relative to each other. The relative motion of the fluid conduit 40 and the piston 42 to the piston housing 32 allows, for example, the first structure 10 to move relative to the second structure 12, or vice versa, and still allow fluid to flow between the first and second structures 10, 12. For example in FIG. 4A, the fluid conduit 40 and the piston 42 are shown shifted slightly to the right relative to the piston housing 32 in one embodiment during use.

The static pressure P_{S} of the fluid in the slip joint 30 causes a plug load or force F_{PL} that tends to push the fluid conduit 40 and the piston 42 towards the left relative to the piston housing 32 and the first and second sealing assemblies 36, 38. In other words, the plug load F_{PL} tends to push piston 42 towards the left within the piston chamber 34. To counteract that plug load F_{PL}, the fluid conduit 40 may include one or more fluid passageways 56 connecting the internal passageway 52 to a pressure chamber 58 in the piston chamber 34 defined between an end surface 60 of the piston 42 and an end surface 62 of the second sealing assembly 38. The fluid passageways 56 allow a pressure P_{C} within the pressure chamber 58 to be substantially equal to the static pressure P_{S} of the fluid flowing through the slip joint 30. Another pressure chamber 64 is defined between an opposite end surface 66 of the piston 42 and an end surface 68 of the first sealing assembly 36. In an embodiment, the pressure chamber 64 may include a vent conduit 70 that is in fluid communication with the external atmosphere outside of the slip joint 30. As such, the pressure chamber 64 experiences ambient pressure of the external atmosphere even when the piston 42 moves within the piston chamber 34. That is, the pressure in the pressure chamber 64 does not increase or decrease as function of the movement of the piston 42 inside the piston chamber 34. Instead, the pressure in the pressure chamber 64 remains substantially at the ambient pressure despite movement of the piston 42 inside the piston chamber 34. Consequently, the ambient pressure in the pressure chamber 64 provides little to no backpressure against or resistance to the movement of the piston 42 inside the piston chamber 34.

In an embodiment shown in FIG. 4B, a fluid conduit 74 may be made from a first fluid conduit section 74a and second fluid conduit section 74b, where a piston 76 is integrally formed with one of the first or second fluid conduit sections 74a, 74b. In FIG. 4B, the piston 76 is shown integrally formed with the first fluid conduit section 74a, for example. In one embodiment, the remaining fluid conduit section 74a, 74b may be abutted in end-to-end relationship to the piston 76 to thereby form the complete fluid conduit 74. However, other arrangements and engagements of the first and second fluid conduit sections 74a, 74b, may possible as well. All other aspects of the fluid conduit 74 and piston 76 are the same as the fluid conduit 40 and the piston 42 shown in FIG. 4, such as the fluid passageways 56, the end surfaces 60, 66, the sealing members 84, and the wear sleeve 86. The two-section fluid conduit 74 with the integral piston 76 provides an efficient way to customize the length of the fluid conduit 74 during assembly depending upon the particular implementation of the slip joint 30.

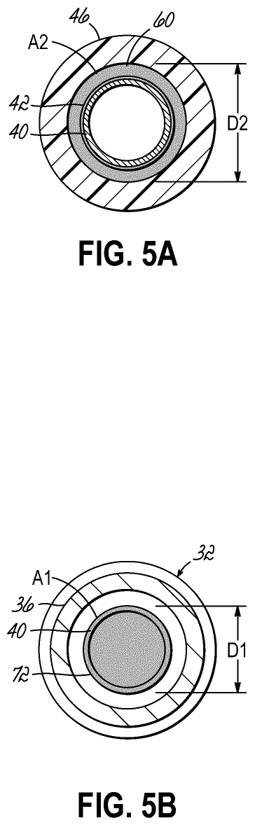

With reference to FIGS. 4, 5A, and 5B, an end face 72 of the fluid conduit 40 has an outer diameter D1 that defines a cross-sectional area A1, also referred to as “area A1”, (FIG. 5B) and the end surface 60 of piston 42 defines an annular cross-sectional surface area A2, also referred to as “surface area A2”, with an outer diameter D2 (FIG. 5A). To counteract the static pressure P_{S} acting on the area A1 (i.e., the plug load F_{PL}) of the fluid conduit 40, the surface area A2 needs to be substantially equal to the area A1. That is, to yield a pressure-balanced slip joint, P_{S}*area A1=P_{S}*surface area A2. The fluid passageways 56 allow the surface area A2 to experience the same static pressure P_{S} that the rest of the internal components of the slip joint 30 also experience, including the area A1 so that the slip joint 30 is pressure-balanced. By providing internal pressurization of the pressure chamber 58, the slip joint 30 does not require any external pressurization to achieve a pressure balance condition within the slip joint 30. Such internal pressurization minimizes the complexity, size, and weight of the slip joint 30 compared to known externally pressurized slip joints.

Depending upon the application of the slip joint 30, there may be circumstances where it may be advantageous for the area A1 to not equal the surface area A2 such that there may be a tensile or compressive load on the slip joint 30. For example, in an embodiment, the area A1 may be greater than the surface area A2. In another embodiment, the area A1 may be less than the surface area A2.

The first and second sealing assemblies 36, 38 may include at least one sealing member 80 and at least one wear sleeve 82, both of which are in sealing engagement with the fluid conduit 40. The piston 42 may include at least one sealing member 84 and at least one wear sleeve 86, both of which are in sealing engagement with the piston housing 32. The second sealing assembly 38 may further include a rod wiper 88 in sealing engagement with the fluid conduit 40.

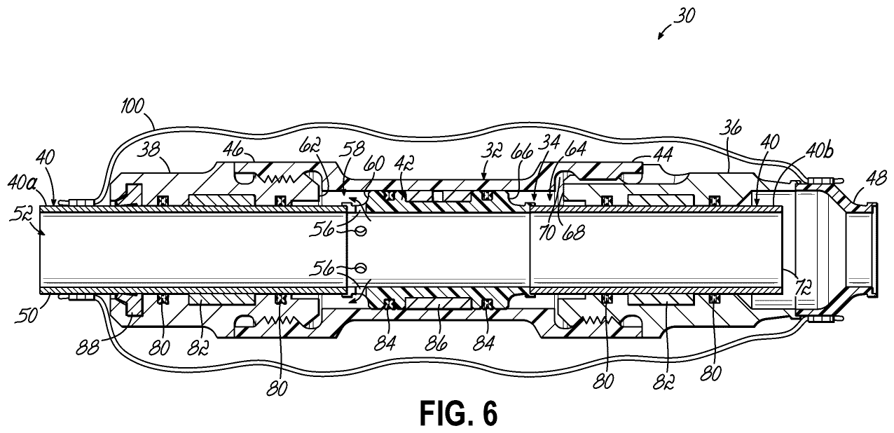

In some applications, the slip joint 30 may be exposed to significantly elevated temperatures. Consequently, the sealing members 80, 84, the wear sleeves 82, 86, and the rod wiper 88 may need to be protected from the elevated temperatures otherwise they may become damaged and be unable to function as designed. To that end, a heat shroud 100 may be used to envelope the majority of the slip joint 30 as shown in FIG. 6 to minimize heat transfer into the first and second sealing assemblies 36, 38 and the piston housing 32. In the embodiment shown in FIG. 6, the heat shroud 100 is coupled to the fluid conduit coupler 48 at one end and is coupled to the exposed end of the fluid conduit 40 at the other end. The heat shroud 100 may be sufficiently flexible to allow for the heat shroud 100 to move as the fluid conduit 40 moves. The heat shroud 100 may be an AS1072 fire sleeve, which may be removable so that the slip joint 30 may be serviced.

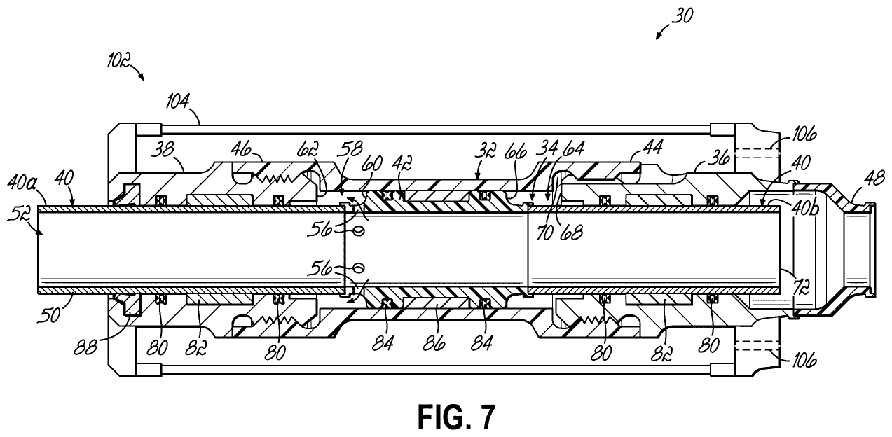

In another embodiment shown in FIG. 7, a heat shroud 102 is coupled to the first sealing assembly 36 at one end and is coupled to the second sealing assembly 38 at the other end. The heat shroud 102 may be a metallic shroud and may be integrally formed with the first and second sealing assemblies 36, 38. The heat shroud 102 may include a cover 104 that is removable so that the slip joint 30 may be serviced. The heat shroud 102 may include one or more vents 106 that is in fluid communication with the external atmosphere outside of the slip joint 30 to relieve pressure build-up within the interior encased by the heat shroud 102 when the slip joint 30 experiences elevated temperature.

As described above, the slip joint 30 is pressure balanced by equating the surface area A2 to the area A1. The magnitude of the surface area A2 is a function, in part, of the outer diameter D2 (FIG. 5A) of the piston 42. Moreover, the outer diameter D2 impacts the overall external diameter of the slip joint 30. In certain applications, the overall external diameter of the slip joint 30 may need to be reduced. To achieve that reduced overall external diameter of the slip joint 30, the outer diameter D2 of the piston 42 may be reduced. If the outer diameter D2 is reduced, however, the surface area A2 will also decrease with everything else being held constant. Consequently, the surface area A2 will no longer equal the area A1 and the slip joint 30 will no longer be pressure balanced.

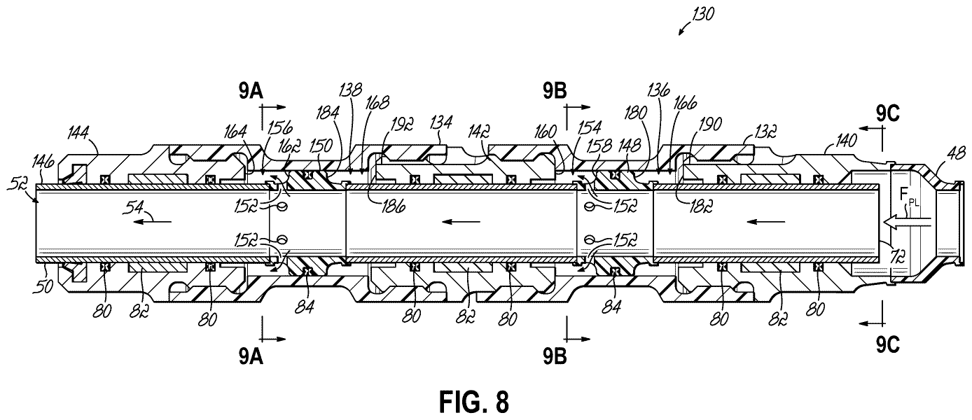

One approach to make up for the reduced outer diameter D2 of the piston 42 is to have a slip joint with a plurality of pistons such that the sum of all the areas of the pistons equals the area A1. To that end, a pressure-balanced slip joint 130 according to another embodiment of the disclosure is shown in FIG. 8. The slip joint 130 is similar to slip joint 30 (FIG. 4) and like elements will have like reference numbers. The slip joint 130 includes a first piston housing 132 and a second piston housing 134, which are spaced apart and each defining a first piston chamber 136 and a second piston chamber 138. The slip joint 130 further includes first, second, and third sealing assemblies 140, 142, 144, which are spaced apart, a fluid conduit 146, and first and second pistons 148, 150 disposed within corresponding ones of the first and second piston chambers 136, 138, each piston 148, 150 being operatively coupled to the fluid conduit 146. Adjacent first and second sealing assemblies 140, 142 are operatively coupled to opposite ends of the first piston housing 132 and adjacent second and third sealing assemblies 142, 144 are operatively coupled to opposite ends of the second piston housing 134. The fluid conduit coupler 48 may be coupled to the first sealing assembly 140. The fluid conduit 146 may be a continuous conduit or it may be in a plurality of sections like the three sections shown in FIG. 8 with the first and second pistons 148, 150 disposed between and coupled to the three sections. In this arrangement, the first and second pistons 148, 150 form part of the internal passageway 52 along with the three sections of the fluid conduit 146. The fluid conduit 146 and the first and second pistons 148, 150 are configured to move relative to the first and second piston housings 132, 134. The movement of the fluid conduit 146 and the first and second pistons 148, 150 may be linear and/or rotational relative to the first and second piston housings 132, 134.

The fluid conduit 146 may include one or more fluid passageways 152 connecting the internal passageway 52 to first and second pressure chambers 154, 156. The first pressure chamber 154 is defined between an end surface 158 of the first piston 148 and an end surface 160 of the second sealing assembly 142. The second pressure chamber 156 is defined between an end surface 162 of the second piston 150 and an end surface 164 of the third sealing assembly 144. The first and second piston chambers 136, 138 further include respective third and fourth pressure chambers 166, 168. The third pressure chamber 166 is defined between a second end surface 180 of the first piston 148 and an end surface 182 of the first sealing assembly 140. The fourth pressure chamber 168 is defined between a second end surface 184 of the first piston 150 and an end surface 186 of the second sealing assembly 142. In an embodiment, the third and fourth pressure chambers 166, 168 may include respective vent conduits 190, 192 that are in fluid communication with the external atmosphere outside the slip joint 130. As such, the third and fourth pressure chambers 166, 168 experience ambient pressure of the external atmosphere even when the first and second pistons 148, 150 move within the first and second piston chambers 136, 138. In an embodiment, the heat shroud 100 may be used to envelope the majority of the slip joint 130 to minimize the heat transfer into the first, second, and third sealing assemblies 140, 142, 144 and the first and second piston housings 132, 134.

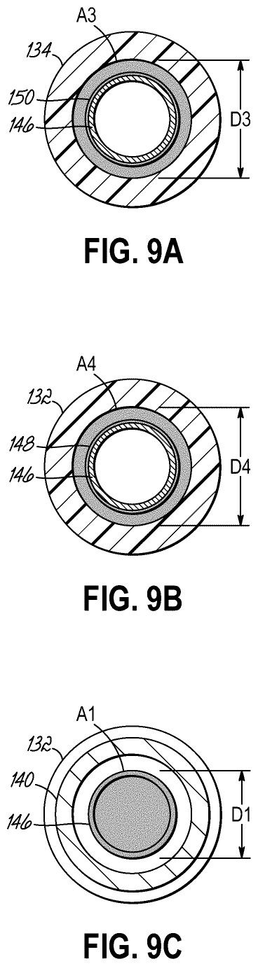

With reference to FIGS. 8, 9A, 9B, and 9C, each of the end surfaces 158, 162 of the first and second pistons 148, 150 defines a respective annular cross-sectional surface area A3, also referred to as “surface area A3”, (FIG. 9A) and an annular cross-sectional surface area A4, also referred to as “surface area A4”, (FIG. 9B) with surface area A3 having an outer diameter D3 and surface area A4 having an outer diameter D4. Outer diameters D3 and D4 are less than the outer diameter D2 and surface areas A3 and A4 are less than the surface area A2 in FIG. 5A. To counteract the static pressure P_{S} acting on the area A1 of the fluid conduit 146, the sum of surface area A3 and surface area A4 should be substantially equal to the area A1. That is, to yield a pressure-balanced slip joint, P_{S}*(surface area A3+surface area A4)=P_{S}*area A1.

Depending upon the application of the slip joint 130, there may circumstances where it may be advantageous for the area A1 to not equal (surface area A3+surface area A4) such that there may be a tensile or compressive load on the slip joint 130. For example, in an embodiment, the area A1 may be greater than (surface area A3+surface area A4). In another embodiment, the area A1 may be less than (surface area A3+surface area A4).

While slip joint 130 is shown with two pistons 148, 150, additional pistons may be added if the slip joint needs to be further reduced in its diameter. To accommodate the further reduction in the diameter of the surface end of the pistons, additional pistons may be added along with additional sealing assemblies. In the end to achieve a pressure-balanced slip joint, the sum of all areas (area A_{AP}) of N number of pistons needs to substantially equal the area of the fluid conduit (area A_{FC}), i.e., area A_{FC}=N*area A_{AP}.

Further aspects of the present disclosure are provided by the subject matter of the following clauses:

A pressure-balanced slip joint, comprising: a piston housing defining a piston chamber; a first sealing assembly threadingly coupled to one end of the piston housing; a second sealing assembly threadingly coupled to an opposite end of the piston housing; a fluid conduit having a tubular wall defining an internal passageway, the internal passageway configured to allow a fluid to flow therethrough, the fluid having a static pressure P_{S}; and a piston disposed within the piston chamber and operatively coupled to the fluid conduit, the fluid conduit and the piston configured to move relative to the piston housing, wherein a first pressure chamber is defined between a first end surface of the piston and an end surface of the first sealing assembly and wherein a second pressure chamber is defined between a second end surface of the piston and an end surface of the second sealing assembly, and wherein the fluid conduit has a fluid passageway connecting the internal passageway of the fluid conduit to the second pressure chamber to allow the fluid to flow therebetween so that a static pressure in the second pressure chamber is the static pressure P_{S}.

The slip joint of any preceding clause, wherein the fluid conduit includes a first fluid conduit section and a second fluid conduit section operatively coupled to the piston.

The slip joint of any preceding clause, wherein the first pressure chamber has a vent conduit to allow fluid at ambient pressure in an out of the first pressure chamber as the piston moves within the piston chamber.

The slip joint of any preceding clause, wherein the fluid conduit has an end face with an outer diameter D1 that defines a cross-sectional area A1 and wherein the second end surface of the piston defines an annular cross-sectional surface area A2, wherein the cross-sectional area A1 is substantially equal to the annular cross-sectional surface area A2.

The slip joint of any preceding clause, wherein the fluid conduit has an end face with an outer diameter D1 that defines a cross-sectional area A1 and wherein the second end surface of the piston defines an annular cross-sectional surface area A2, wherein the cross-sectional area A1 is not equal to the annular cross-sectional surface area A2.

The slip joint of any preceding clause, wherein the fluid conduit and the piston are adapted to move linearly and rotationally relative to the piston chamber.

The slip joint of any preceding clause, further comprising a heat shroud surrounding the first sealing assembly, the second sealing assembly, and the piston housing, the heat shroud adapted to minimize heat transfer into the first and second sealing assemblies and the piston housing.

The slip joint of any preceding clause, wherein the heat shroud is flexible so as to allow the fluid conduit to move relative to the first and second sealing assemblies and the piston housing.

A pressure-balanced slip joint, comprising: a plurality of spaced-apart piston housings, each piston housing defining a piston chamber; a plurality of spaced-apart sealing assemblies, each adjacent pair of sealing assemblies being operatively coupled to opposite ends of a corresponding one of the plurality of piston housings; a fluid conduit having a tubular wall defining an internal passageway, the internal passageway configured to allow fluid flow therethrough, the fluid having a static pressure P_{S}; a plurality of pistons, each piston disposed within a corresponding one of the plurality of piston chambers and operatively coupled to the fluid conduit, wherein each piston in each piston chamber defines a first pressure chamber between a first end surface of the piston and an end surface of one of the adjacent sealing assemblies and further defines a second pressure chamber between a second end surface of the piston and an end surface of the other adjacent sealing assembly, wherein the fluid conduit and the plurality of pistons are configured to move relative to the plurality of piston chambers, and wherein the fluid conduit has at least one fluid passageway associated with each piston chamber to thereby connect the internal passageway of the fluid conduit to each of the respective second pressure chambers to allow fluid to flow therebetween so that a static pressure in each of the second pressure chambers is the static pressure P_{S}.

The slip joint of any preceding clause, wherein each first pressure chamber has a vent conduit to allow fluid at ambient pressure in an out of each respective first pressure chamber as each piston moves within each respective piston chamber.

The slip joint of any preceding clause, wherein the fluid conduit has an end face with an outer diameter D1 that defines a cross-sectional area A1 and wherein the second end surface of each piston defines an annular cross-sectional surface area A3, wherein N equals the number of pistons, and wherein the cross-sectional area A1 is substantially equal to the annular cross-sectional surface area A3 times N.

The slip joint of any preceding clause, wherein the fluid conduit has an end face with an outer diameter D1 that defines a cross-sectional area A1 and wherein the second end surface of the piston defines an annular cross-sectional surface area A3, wherein N equals the number of pistons, and wherein the cross-sectional area A1 is not equal to the annular cross-sectional surface area A3 times N.

The slip joint of any preceding clause, wherein the fluid conduit and the plurality of pistons are configured to move linearly and rotationally relative to the plurality of piston chambers.

The slip joint of any preceding clause, further comprising a heat shroud surrounding the plurality of sealing assemblies and the plurality of piston housings, the heat shroud adapted to minimize heat transfer into the plurality of sealing assemblies and the plurality of piston housings.

The slip joint of any preceding clause, wherein the heat shroud is flexible so as to allow the fluid conduit to move relative to the plurality of sealing assemblies and the plurality of piston housings.

A pressure-balanced slip joint, comprising: a piston housing defining a piston chamber; a first sealing assembly operatively coupled to one end of the piston housing; a second sealing assembly operatively coupled to an opposite end of the piston housing; a fluid conduit having a first fluid conduit section and a second fluid conduit section, each of the first and second fluid conduit sections having a tubular wall defining an internal passageway, the internal passageway configured to allow a fluid to flow therethrough, the fluid having a static pressure P_{S}; and a piston disposed within the piston chamber and being integrally formed with the first fluid conduit section of the fluid conduit, wherein the second fluid conduit section is abutting against and operatively coupled to the piston, the fluid conduit and the piston configured to move relative to the piston housing, wherein a first pressure chamber is defined between a first end surface of the piston and an end surface of the first sealing assembly and wherein a second pressure chamber is defined between a second end surface of the piston and an end surface of the second sealing assembly, and wherein the fluid conduit has a fluid passageway connecting the internal passageway of the fluid conduit to the second pressure chamber to allow the fluid to flow therebetween so that a static pressure in the second pressure chamber is the static pressure P_{S}.

The slip joint of any preceding clause, wherein the fluid conduit has an end face with an outer diameter D1 that defines a cross-sectional area A1 and wherein the second end surface of the piston defines an annular cross-sectional surface area A2, wherein the cross-sectional area A1 is substantially equal to annular cross-sectional surface area A2.

The slip joint of any preceding clause, wherein the fluid conduit has an end face with an outer diameter D1 that defines a cross-sectional area A1 and wherein the second end surface of the piston defines an annular cross-sectional surface area A2, wherein the cross-sectional area A1 is not equal to the annular cross-sectional surface area A2.

The slip joint of any preceding clause, wherein the fluid conduit and the piston are adapted to move linearly and rotationally relative to the piston chamber.

The slip joint of any preceding clause, further comprising a heat shroud surrounding the first sealing assembly, the second sealing assembly, and the piston housing, the heat shroud adapted to minimize heat transfer into the first and second sealing assemblies and the piston housing.

The slip joint of any preceding clause, wherein each of the first and second sealing assemblies includes at least one sealing member in sealing engagement with the fluid conduit.

The slip joint of any preceding clause, wherein each of the first and second sealing assemblies includes at least one wear sleeve in sealing engagement with the fluid conduit.

The slip joint of any preceding clause, wherein the piston includes at least one sealing member in sealing engagement with the fluid conduit.

The slip joint of any preceding clause, wherein the piston includes at least one wear sleeve in sealing engagement with the fluid conduit.

The slip joint of any preceding clause, wherein the second sealing assembly includes a rod wiper in sealing engagement with the fluid conduit.

While the present disclosure has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The present disclosure in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A pressure-balanced slip joint, comprising:
a piston housing defining a piston chamber;
a first sealing assembly threadingly coupled to one end of the piston housing;
a second sealing assembly threadingly coupled to an opposite end of the piston housing;
a fluid conduit having a tubular wall defining an internal passageway, the internal passageway configured to allow a fluid to flow therethrough, the fluid having a static pressure P_{S}; and
a piston disposed within the piston chamber and operatively coupled to the fluid conduit, the fluid conduit and the piston configured to move relative to the piston housing,
wherein a first pressure chamber is defined between a first end surface of the piston and an end surface of the first sealing assembly and wherein a second pressure chamber is defined between a second end surface of the piston and an end surface of the second sealing assembly, and
wherein the fluid conduit has a fluid passageway connecting the internal passageway of the fluid conduit to the second pressure chamber to allow the fluid to flow therebetween so that a static pressure in the second pressure chamber is the static pressure P_{S}.

2. The slip joint of claim 1, wherein the fluid conduit includes a first fluid conduit section and a second fluid conduit section operatively coupled to the piston.

3. The slip joint of claim 1, wherein the first pressure chamber has a vent conduit to allow fluid at ambient pressure in and out of the first pressure chamber as the piston moves within the piston chamber.

4. The slip joint of claim 1, wherein the fluid conduit has an end face with an outer diameter D1 that defines a cross-sectional area A1 and wherein the second end surface of the piston defines an annular cross-sectional surface area A2, wherein the cross-sectional area A1 is substantially equal to the annular cross-sectional surface area A2.

5. The slip joint of claim 1, wherein the fluid conduit has an end face with an outer diameter D1 that defines a cross-sectional area A1 and wherein the second end surface of the piston defines an annular cross-sectional surface area A2, wherein the cross-sectional area A1 is not equal to the annular cross-sectional surface area A2.

6. The slip joint of claim 1, wherein the fluid conduit and the piston are adapted to move linearly and rotationally relative to the piston chamber.

7. The slip joint of claim 1, further comprising a heat shroud surrounding the first sealing assembly, the second sealing assembly, and the piston housing, the heat shroud adapted to minimize heat transfer into the first and second sealing assemblies and the piston housing.

8. The slip joint of claim 7, wherein the heat shroud is flexible so as to allow the fluid conduit to move relative to the first and second sealing assemblies and the piston housing.

9. A pressure-balanced slip joint, comprising:
a plurality of spaced-apart piston housings, each piston housing defining a piston chamber;
a plurality of spaced-apart sealing assemblies, each adjacent pair of sealing assemblies being operatively coupled to opposite ends of a corresponding one of the plurality of piston housings;
a fluid conduit having a tubular wall defining an internal passageway, the internal passageway configured to allow a fluid to flow therethrough, the fluid having a static pressure P_{S};
a plurality of pistons, each piston disposed within a corresponding one of the plurality of piston chambers and operatively coupled to the fluid conduit,
wherein each piston in each piston chamber defines a first pressure chamber between a first end surface of the piston and an end surface of one of the adjacent sealing assemblies and further defines a second pressure chamber between a second end surface of the piston and an end surface of the other adjacent sealing assembly,
wherein the fluid conduit and the plurality of pistons are configured to move relative to the plurality of piston chambers, and
wherein the fluid conduit has at least one fluid passageway associated with each piston chamber to thereby connect the internal passageway of the fluid conduit to each of the respective second pressure chambers to allow the fluid to flow therebetween so that a static pressure in each of the second pressure chambers is the static pressure P_{S}.

10. The slip joint of claim 9, wherein each first pressure chamber has a vent conduit to allow fluid at ambient pressure in an out of each respective first pressure chamber as each piston moves within each respective piston chamber.

11. The slip joint of claim 9, wherein the fluid conduit has an end face with an outer diameter D1 that defines a cross-sectional area A1 and wherein the second end surface of each piston defines an annular cross-sectional area A3, wherein N equals the number of pistons, and wherein the cross-sectional area A1 is substantially equal to the annular cross-sectional area A3 times N.

12. The slip joint of claim 9, wherein the fluid conduit has an end face with an outer diameter D1 that defines a cross-sectional area A1 and wherein the second end surface of the piston defines an annular cross-sectional area A3, wherein N equals the number of pistons, and wherein the cross-sectional area A1 is not equal to the annular-cross-sectional area A3 times N.

13. The slip joint of claim 9, wherein the fluid conduit and the plurality of pistons are configured to move linearly and rotationally relative to the plurality of piston chambers.

14. The slip joint of claim 9, further comprising a heat shroud surrounding the plurality of sealing assemblies and the plurality of piston housings, the heat shroud adapted to minimize heat transfer into the plurality of sealing assemblies and the plurality of piston housings.

15. The slip joint of claim 14, wherein the heat shroud is flexible so as to allow the fluid conduit to move relative to the plurality of sealing assemblies and the plurality of piston housings.

16. A pressure-balanced slip joint, comprising:
a piston housing defining a piston chamber;
a first sealing assembly operatively coupled to one end of the piston housing;
a second sealing assembly operatively coupled to an opposite end of the piston housing;
a fluid conduit having a first fluid conduit section and a second fluid conduit section, each of the first and second fluid conduit sections having a tubular wall defining an internal passageway, the internal passageway configured to allow a fluid to flow therethrough, the fluid having a static pressure P_{S}; and
a piston disposed within the piston chamber and being integrally formed with the first fluid conduit section of the fluid conduit, wherein the second fluid conduit section is abutting against and operatively coupled to the piston, the fluid conduit and the piston configured to move relative to the piston housing,
wherein a first pressure chamber is defined between a first end surface of the piston and an end surface of the first sealing assembly and wherein a second pressure chamber is defined between a second end surface of the piston and an end surface of the second sealing assembly, and
wherein the fluid conduit has a fluid passageway connecting the internal passageway of the fluid conduit to the second pressure chamber to allow the fluid to flow therebetween so that a static pressure in the second pressure chamber is the static pressure P_{S}.

17. The slip joint of claim 16, wherein the fluid conduit has an end face with an outer diameter D1 that defines a cross-sectional area A1 and wherein the second end surface of the piston defines an annular cross-sectional surface area A2, wherein the cross-sectional area A1 is substantially equal to the annular cross-sectional surface area A2.

18. The slip joint of claim 16, wherein the fluid conduit has an end face with an outer diameter D1 that defines a cross-sectional area A1 and wherein the second end surface of the piston defines an annular cross-sectional surface area A2, wherein the cross-sectional area A1 is not equal to the annular cross-sectional surface area A2.

19. The slip joint of claim 16, wherein the fluid conduit and the piston are adapted to move linearly and rotationally relative to the piston chamber.

20. The slip joint of claim 16, further comprising a heat shroud surrounding the first sealing assembly, the second sealing assembly, and the piston housing, the heat shroud adapted to minimize heat transfer into the first and second sealing assemblies and the piston housing.
